(19) United States
(12) Patent Application Publication
(10) Pub. No.: US 2021/0266254 A1
(43) Pub. Date: Aug. 26, 2021

(54) DEVICE TO DEVICE FORWARDING

(71) Applicant: IDAC Holdings, Inc., Wilmington, DE (US)

(72) Inventors: Dirk TROSSEN, London (GB); Ulises OLVERA-HERNANDEZ, London (GB)

(21) Appl. No.: 17/255,082

(22) PCT Filed: Jun. 14, 2019
(86) PCT No.: PCT/US2019/037254

§ 371 Date: Dec. 22, 2020

Related U.S. Application Data
(60) Provisional application No. 62/688,699, filed on Jun. 22, 2018.
(60) Provisional application No. 62/749,957, filed on Oct. 24, 2018.

(51) Int. Cl. H04L 12/721; H04L 12/717; H04L 12/741; H04W 80/02; H04W 40/02

(52) U.S. Cl. CPC H04L 45/66; H04L 45/42; H04W 40/02; H04W 80/02; H04L 45/74

(57) ABSTRACT

Systems, devices, and methods for addressing one or more approaches to path based forwarding is described. A packet frame format for a suitable layer may be used for the delivery of layer 2 packets across User Plane Functions (UPFs). Forwarding the packet frame format from an originating source wireless transmit receive unit (WTRU) over a first UPF to a second UPF, where the second UPF may then send the packet to a destination WTRU. The forwarding may be achieved by suitably swapping information for link-local layer 2 delivery at traversing UPFs. Further, path computation may be performed for registered layer 2 and above services in layer 2 forwarding. Also, forwarding HTTP/IP-over-ICN use cases for HTTP/IP communication over 5G native L2 bearer may be implemented.

### BACKGROUND

In wireless communications networks devices may need to interact with each other using one or more protocols. The devices may need to send and receive data packets that need to be routed through one or more networks. In implementing various techniques of routing packets, there may be limitations and issues that arise, such as scalability, that need to be addressed.

### SUMMARY

Systems, devices, and methods for addressing one or more approaches to path based forwarding. A packet frame format for a suitable layer may be used for the delivery of layer 2 packets across User Plane Functions (UPFs). Forwarding the packet frame format from an originating source wireless transmit receive unit (WTRU) over first UPF to a second UPF, where the second UPF may then send the packet to a destination WTRU. The forwarding may be achieved by suitably swapping information for link-local layer 2 delivery at traversing UPFs. Further, path computation may be performed for registered layer 2 and above services in layer 2 forwarding. Also, forwarding HTTP/IP-over-ICN use cases for HTTP/IP communication over 5G native L2 bearer may be implemented.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A illustrates an example architecture according to one or more embodiments;

FIG. 2B illustrates an example architecture according to one or more embodiments;

FIG. 3 illustrates a possible deployment architecture aligned with some 3GPP approaches;

FIG. 4 illustrates an example of a Packet Frame Format used for forwarding approaches;

FIG. 5 illustrates an example of an end-to-end traversal of a packet;

FIG. 6A shows an example flowchart for source AN; and

FIG. 6B shows an example flowchart for destination AN.

### DETAILED DESCRIPTION

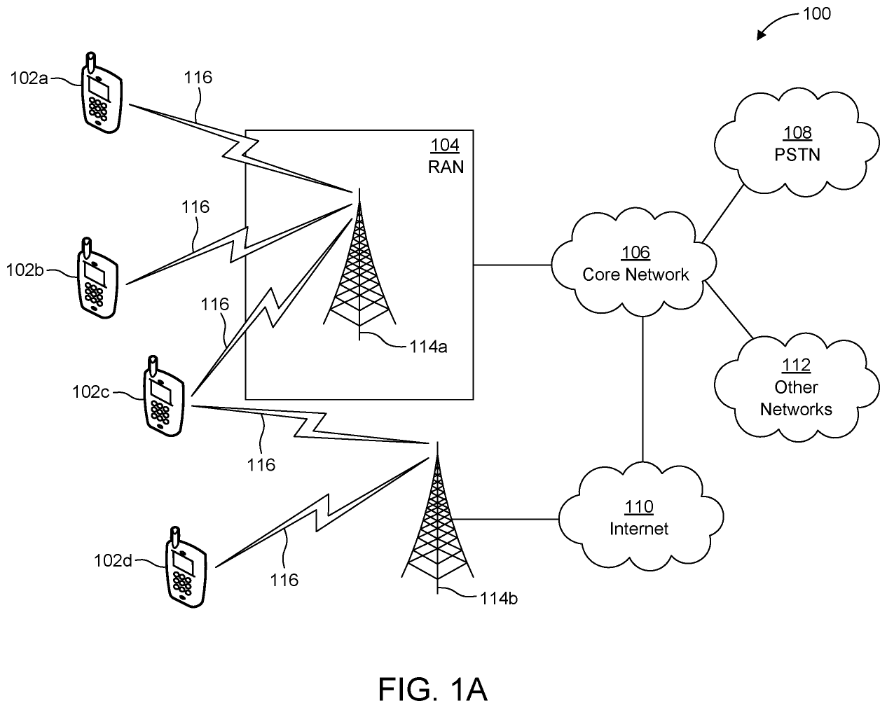

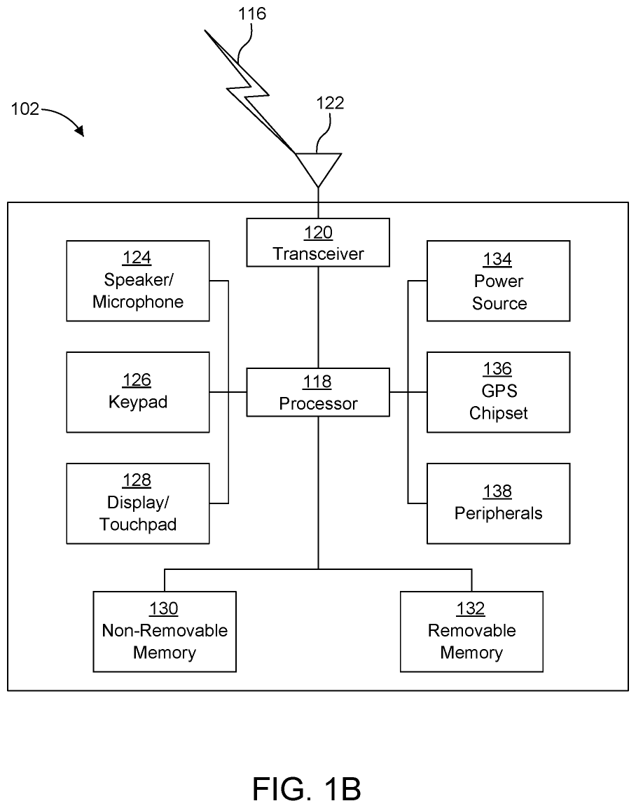

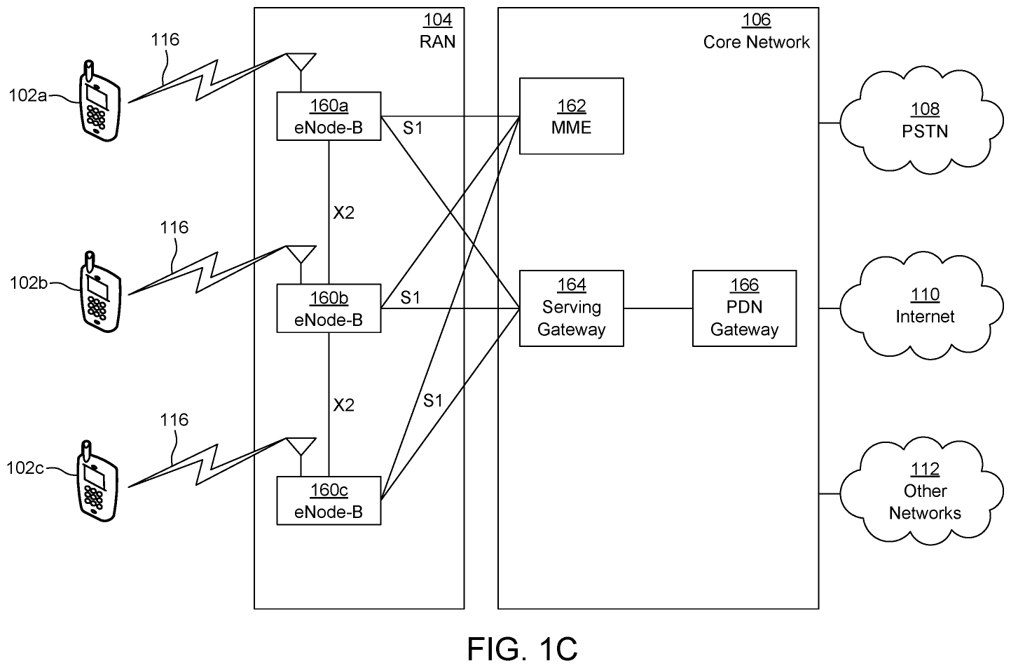

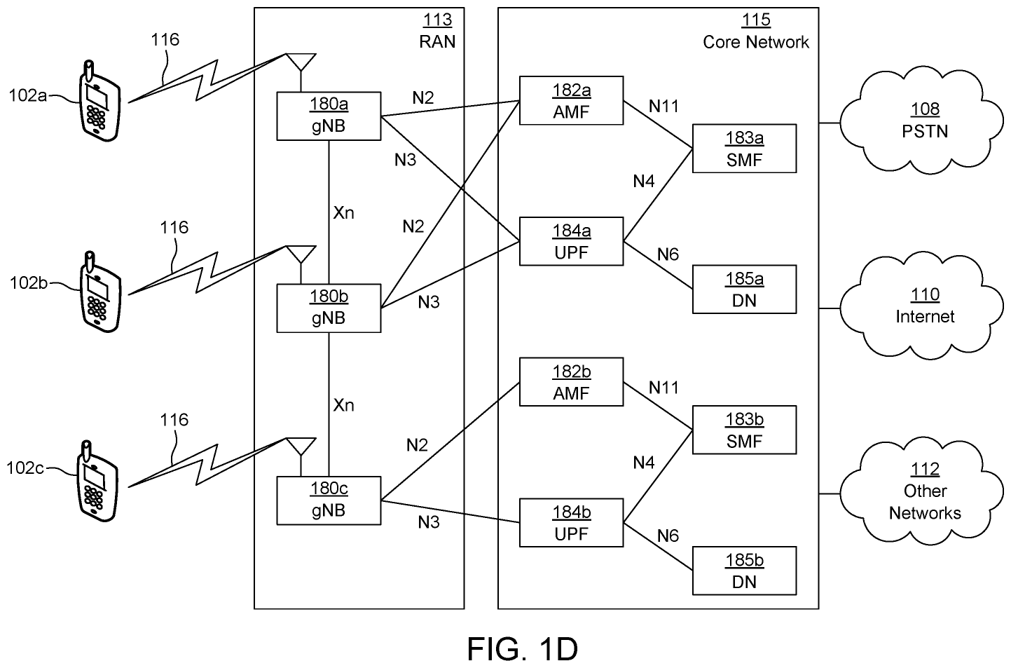

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any instance of at WTRU(s) as discussed herein, such as 102a, 102b, 102c and 102d, may be interchangeably referred to as a UE, and vice versa.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

User plane routing in mobile networks is a crucial function to deliver services to end users. User plane routing in some mobile networks may be realized through a combination of tunneling approaches related to tunneling IP packets towards the packet gateway of the enhanced packet core (EPC) for delivery to Internet-based services. Further, general IP as well as specifically HTTP-based services may be realized by virtue of utilizing information-centric networking (ICN) based approaches to routing. In these approaches, the IP/HTTP packet delivery may be replaced by a publication of the packet to an ICN network, which in turn forwards the packet, after a suitable rendezvous and topology management process, to the suitable service endpoint.

Approaches such as stateless multicast switching in software defined networks (SDN) may be utilized for the ultimate forwarding of the (IP or HTTP) packet to the service endpoint. These approaches may also utilize so-called path-based forwarding, representing each link in the network with a specific bit-position in a fixed sized bit-field. At each incoming forwarder in the network, a simple binary AND/CMP check may be performed that compares each outgoing link of the forwarder that in turn may be designated to the aforementioned specific bit-position with the bit-patterns included in the incoming packet. If the bit-position is set to 1, the packet may be forwarded over the respective outport port. These checks may be done for all output ports of the traversing forwarder.

Further, approaches such as stateless multicast switching may be implementable in existing SDN switches, utilizing an arbitrary wildcard matching capability of SDN switches. For example, placing the bit-pattern to be checked in each switch into the IPv6 source and destination fields may provide suitable backward compatibility, while the simplicity of the binary check in each switch leads to a constant number of forwarding rules to be executed, where the number of rules may equal the number of output ports in each switch.

Path-based forwarding may have some advantages, such as: fast updates for service indirection that allow for fast redirection to new service instances; multicast capability by binary combining path information that may also provide cost savings in virtual reality or HTTP-level streaming scenarios; and/or, direct path mobility which may eliminate the need for anchor-based mobility used in some IP routing.

Such an approach comes, however, with scalability limitations since each link of the network requires its own unique bit-position. This limitation may be addressed by efficient inter-zonal bit-field forwarding, which may allow for larger networks. Such approaches may utilize the payload of each packet to carry forwarding information at the cost of growing packet sizes linear to the size of the delivery networks carrying the packet.

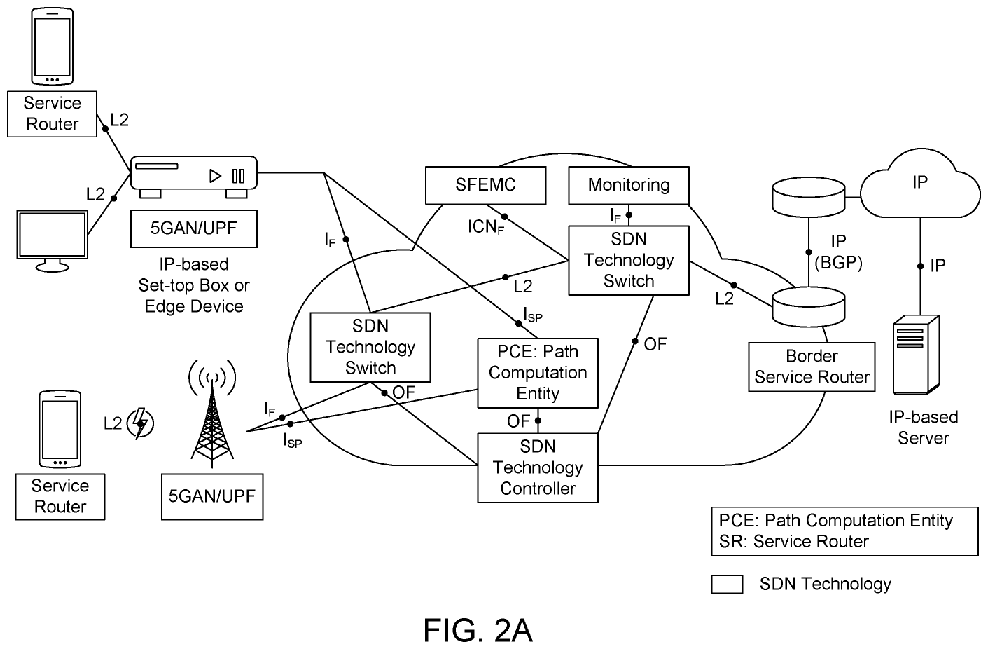

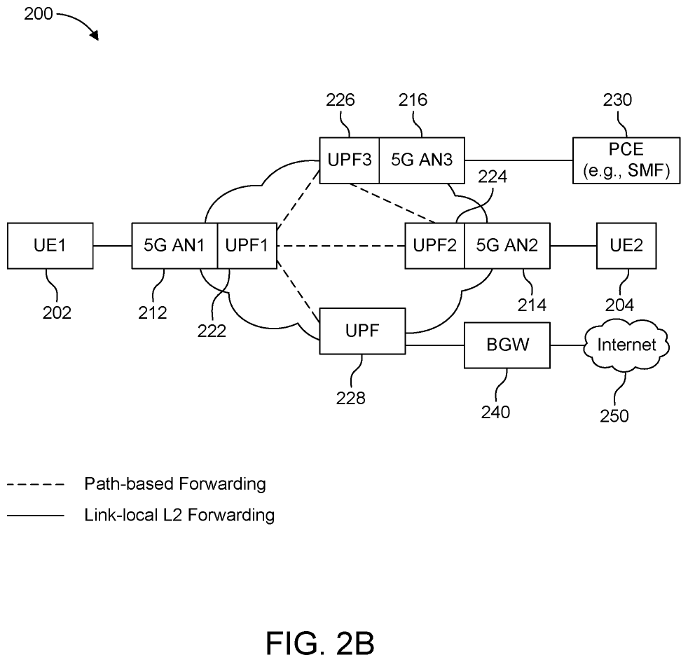

Service-based architecture (SBA) principles for the design of both control planes (CP) as well as user planes (UP) for 5G networks may also be considered. Further, work on (virtual private) LAN connectivity to user equipment (UE) may address SBA-based solutions for UP routing. In one example, there may be an SBA-based CP approach based on anchoring HTTP-level services in ICN networks and anchoring IP devices in ICN networks through IP prefixing. However, the service endpoints in the CP scenarios addressed in such an example may be located in a regional data center, where scalability is not an issue since the termination of the Layer 2 connectivity is located at dedicated Network Attachment Points, interconnecting to the Layer 2 SDN-based network. This example deployment may then utilize approaches of stateless multicast switching in SDN and efficient inter-zonal bit-field forwarding as the forwarding technique in the Layer 2 SDN-based network between those regional data centers. These examples may be illustrated in the architectural example shown in FIG. 2A.

When considering true device to device (i.e., UE-to-UE) connectivity, even an extrapolation of efficient inter-zonal bit-field forwarding approaches may lead to the large forwarding of information that may need to be stored in the traversing packet. With the number of UEs to grow significantly in 5G, such as because of the Internet of Things (IoT), such embedding of full end-to-end path-based information into the packet may not be sustainable.

As discussed herein, one way to address the issues discussed above may be a packet format and forwarding operation that overcomes scalability limitations and provides true end-to-end Layer 2 forwarding from one 5G UE to another, thereby allowing for benefits of path-based forwarding without at least some of the drawbacks. There may be procedures, methods, systems, devices, and architectures for forwarding Layer 2/Ethernet packets from one UE to another UE based on path-based forwarding between 5G access nodes/UPF combo nodes or standalone UPFs, utilizing either a terminal-based or network-based realization of the path-based forwarding. A suitable Layer packet frame format may be constructed for delivery of Layer 2 packets across User Plane Functions (UPFs). The packet frame format may be forwarded from an originating UE over first UPF and second UPF to a destination UE, achieved through suitably swapping information for link-local Layer 2 delivery at traversing UPFs. Further, there may be path computation for registered Layer 2 and above services in such Layer 2 forwarding. Also, there may be the utilization of forwarding in HTTP/IP-over-ICN use cases for HTTP/IP communication over a 5G native L2 bearer.

In one embodiment, a hybrid approach may be to utilize local-link Layer 2 (e.g., Ethernet) forwarding from the UE to the 5G-AN (access node)/UPF combo node or standalone UPF, while utilizing path-based forwarding from one UPF to another. The latter may allow for extensions such as efficient inter-zonal bit-field forwarding for those cases where the number of deployed UPFs is growing beyond the number of supported bit-positions in the available IPv6 src/dst field, while supporting the potential for a growing number of UEs expected with 5G due to utilizing link-local Layer 2 forwarding from the 5GAN/UPF combo to the UE (i.e., decoupling the growth of UEs from the scalability of the UPF-to-UPF forwarding based on path-based approaches).

FIG. 2B illustrates an example architecture according to one or more embodiments. As discussed herein, the system 200 may be divided into path-based forwarding (between UPF to UPF—indicated by dashed lines) and link-local Layer 2 forwarding (between UE and 5GAN/UPF combo—indicated by solid lines), therefore realizing the aforementioned hybrid approach. A pure L2 bearer may be available between the UE 202, 204 and the UPF 222, 224, 226 associated with the 5G Access Network (AN) 212, 214, 216 where the UE is attached. While the architecture may be discussed in the context of UPFs, as discussed herein the UPFs may be replaced by Wi-Fi compliant/UPF access nodes that provide a Layer 2 bearer to attached (Layer 2) devices such as UEs.

The path computation element 230 (PCE) in FIG. 2B may be responsible for path computation between ANs. In an example, the PCE 230 may be implemented in the SMF. The UPFs may realize the packet forwarding operations as discussed herein. The PCE may be connected via its own UPF (not shown), or it may be located on a mobile (or generally 5G-AN connected) device, connected via a 5G-AN/UPF combo 216/226 (as shown in FIG. 2B).

A connection to the Internet 250 (e.g., for HTTP/IP services), may be through a suitable function 240 similar to that of the Packet Gateway (PGW) in a mobile core 5G network, such as the border gateway (BGW). A BGW 240 may be connected directly to the path-based forwarding network through its own UPF 228, based on an approach related to anchoring in ICN networks (e.g., since the BGW may not be a UE-like device but rather a network component akin to an IP-level router).

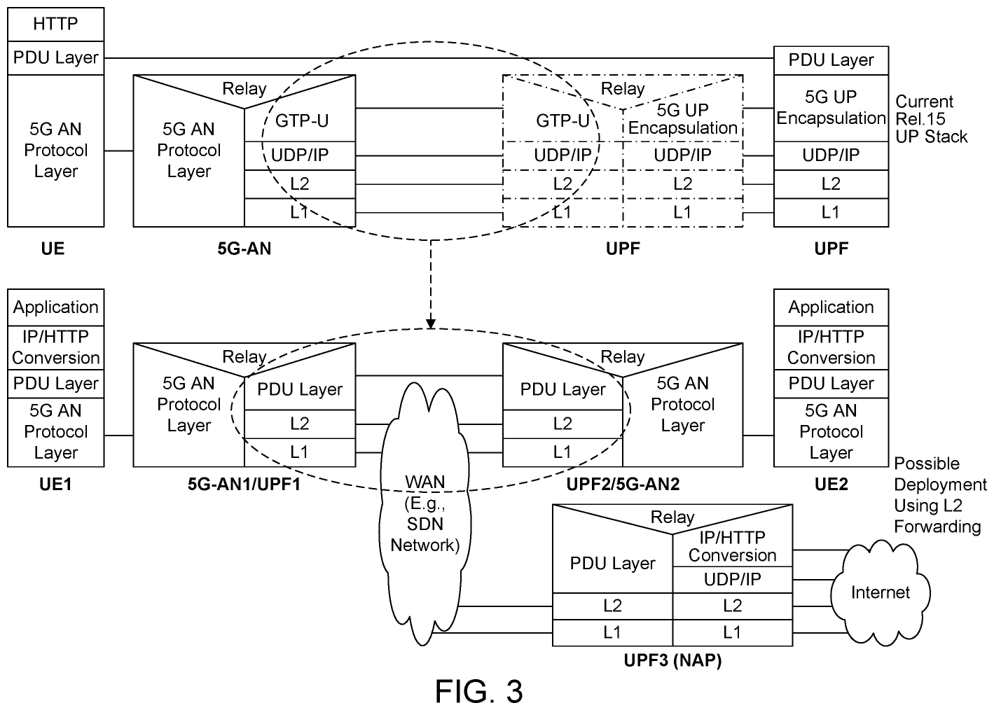

FIG. 3 illustrates a possible deployment architecture aligned with 3GPP approaches. On the top of FIG. 3 there is a 3GPP user plane stack with a GPT-U tunnel between the 5G-AN nodes. There may be a simplified stack compared to the 3GPP approach shown in the bottom of FIG. 3 with a split between 5G-AN towards UE and the UPF between different 5G-AN nodes. For the transfer of Layer 2 messages based on higher-layer semantics, such as those defined in IP or HTTP protocols, methods for mapping HTTP/IP operations onto Layer 2 exchanges related to anchoring in an ICN may be used. Alternatively, standard IP/HTTP protocol stacks may be used. In either case, the transfer may be performed by the grey blocks in the UEs of FIG. 3 and the BGW shown at the bottom of FIG. 3 with a connection to the Internet. The GTP tunneling may be replaced with a L2 exchange based on the packet forwarding methods as disclosed herein. More specifically, the GTP tunneling protocol and the Layer 3 packet forwarding implemented in the 5G-AN node depicted in the top-most protocol stack in FIG. 3 may be replaced with a combination of a 5G-AN and a co-located User Plane Function (UPF). The UPF may realize the PDU Layer component of the 5G-AN/UPF relay depicted in the protocol stack placed at the middle and bottom side of FIG. 3. Note that the PDU Layer showed in UPF1/UPF2 may be required as the UPF needs information contained in the PDU Layer to extract the pathID and UE2MAC address information that will be used for forwarding at L2. This information may be further described herein in relation to the general Packet Frame Format.

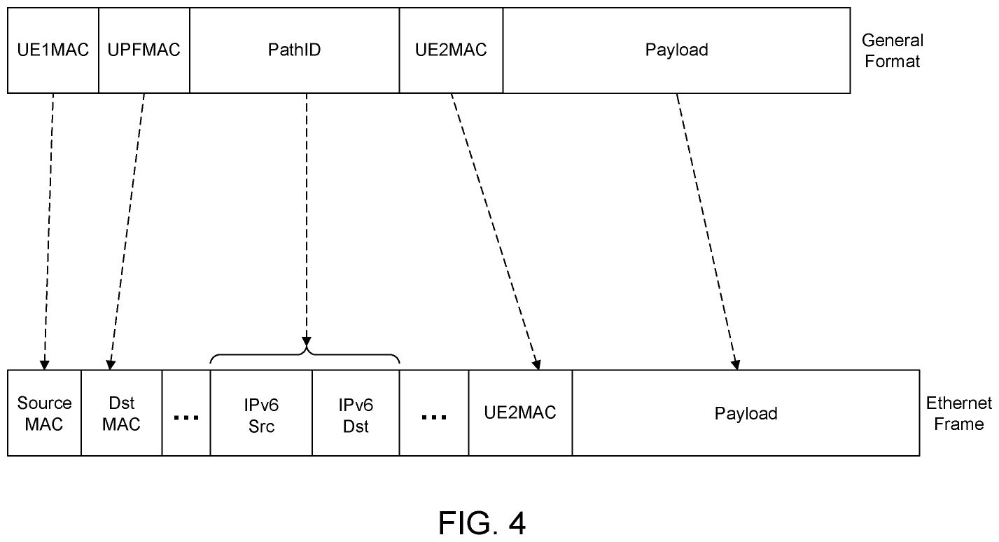

FIG. 4 illustrates an example of a Packet Frame Format used for forwarding approaches discussed herein. The frame format at the top of the FIG. 4 shows one possible format with the following: UE1MAC—L2 MAC address of the originating UE (i.e., that of UE1 in FIG. 2B); UPFMAC—L2 MAC address of the receiving UPF (i.e., that of UPF1 in FIG. 2B); pathID—the bit-field-based path information from source to destination UPF (i.e., UPF1 to UPF2 in FIG. 2B); UE2MAC—L2 MAC address of the receiving UE (i.e., that of UE2 in FIG. 2B); and/or Payload—the payload of the Ethernet frame, where in one example such payload is defined through approaches related to anchoring HTTP or IP message exchanges in an ICN, this payload may include the content ID (CID) and reverse content ID (rCID) derived from an incoming HTTP request together with the actual HTTP request payload. In another example, the CID may be the IP address assigned to UE2 with the payload being the IP packet at UE1.

In an alternative configuration for pathID, the pathID identifier may be defined through a PDU session identifier, which may be used to receive UPF to insert the pathID for traversal through the network. In another alternative, the pathID may be entirely removed from the UE-UPF communication, with the UPG utilizing an internal mapping of UE2MAC to pathID, retrieving the pathID from this mapping and inserting the pathID for UPF-to-UPF traversal.

The lower part of FIG. 4 shows the mapping of the general format onto an Ethernet frame with IP packet payload. The MAC addresses are mapped onto the source/destination MAC information in the Ethernet frame while the path ID utilizes the IPv6 source/destination fields for the path-based forwarding. The destination MAC address (i.e., UE2MAC in FIG. 4.), is transferred as part of the Ethernet frame payload together with the payload of the general format.

Note that the example in FIG. 4 shows the general format for the forward traffic from UE1 to UE2. The MAC information in the general format may change for the specific relationships (e.g., the roles of UE1MAC and UE2MAC reverse in backward traffic from UE2 to UE1 or for communication between UE1 and UE2 towards the PCE).

In considering path computation, the operations in relation to anchoring in an ICN may involve the matching of publications to specific publisher/subscriber information according to ICN semantics (e.g., the publications are those to fully qualified domain names (FQDNs) as provided in incoming HTTP requests). The outcome of the matching of publisher and subscriber (e.g., at the rendezvous (RV) node) may be the sending of a request to the TM node (e.g., which may in turn provide a forwarding identifier as a result of this operation). While some approaches may not be prescriptive to the specific method being used for path calculation, the path computation may result in path identifiers (pathIDs) (i.e., describing the path between two nodes as a bit-array with those bits set to 1 that define the specific links in the network along the path that has been computed). Further, the operations of the RV/TM in some approaches may be jointly provided by the PCE, possibly implemented as a Network Function Service within the SMF or a standalone Network Function Service component shown in FIG. 2B.

In an embodiment, to issue suitable path computation requests to the PCE, the operations of the Network Attachment Point (NAP) realized from approaches related to anchoring in ICN may be implemented in UE1 and UE2 of FIG. 2B, resulting in suitable matching requests sent to the PCE. Further, the UE1 may send a request to the PCE containing the CID and rCID of the HTTP request it wants to send, or alternatively the CID of the IP address of UE2 for IP-level traffic. The PCE may respond to UE1 with suitable pathID information that can be used in the general packet format (see FIG. 4 when sending a request from UE1 to UE2).

In an alternative embodiment, UE1 may also implement the RV matching functionality locally, resulting in a specific path computation request between already identified nodes (e.g., the node UE1 itself and the destination node UE2). In this case, UE1 may send the information corresponding to its own node (e.g., using the UE1MAC and UPF1MAC information) and to node UE2 (e.g., using the UE2MAC and UPF2MAC information). Further, some out-of-band signaling may be required to provide suitable UE2MAC, UPF1MAC and UPF2MAC information. In one example, service function chaining (SFC) may be used where the information may be provided by the Network Service Header (NSH) in combination with the Next Hop Information (NHI) provided to the UE1.

In either embodiment, the request payload may be transferred using the general frame format defined in FIG. 4 with the request parameters (e.g., CID, rCID information for the first embodiment) being provided in the payload shown in FIG. 4. In both cases, the PCE may respond with suitable pathID information carried in the payload of the general format in FIG. 4.

The packet forwarding operations as disclosed herein may be used for the transfer from the requesting UE to the PCE similar to a normal data transfer from a UE to another one. In the case of the UE-PCE communication, the UE may have knowledge of the suitable information used in the general frame format of FIG. 4. Specifically, the pathID from UPF1 to UPF3 may be known as well as PCEMAC in the example of FIG. 4. Such information may be provided as part of the procedure to attach UE1 to 5G AN1.

As with SDN related approaches, the PCE may configure the suitable forwarding rules in the Layer 2 switches of the forwarding network in FIG. 2B. Those forwarding rules may act on the pathID in the general frame format, specifically that of the Ethernet frame mapping in FIG. 4. In such SDN related approaches, those rules in each forwarding switch may check the pathID information for a specific bit to be set to 1, such bit defining the specific output port of the switch. The configuration of the forwarding rules in each intermediary switch may take place upon bootstrapping of the forwarding network in FIG. 2B or upon changes to any network equipment within the forwarding network.

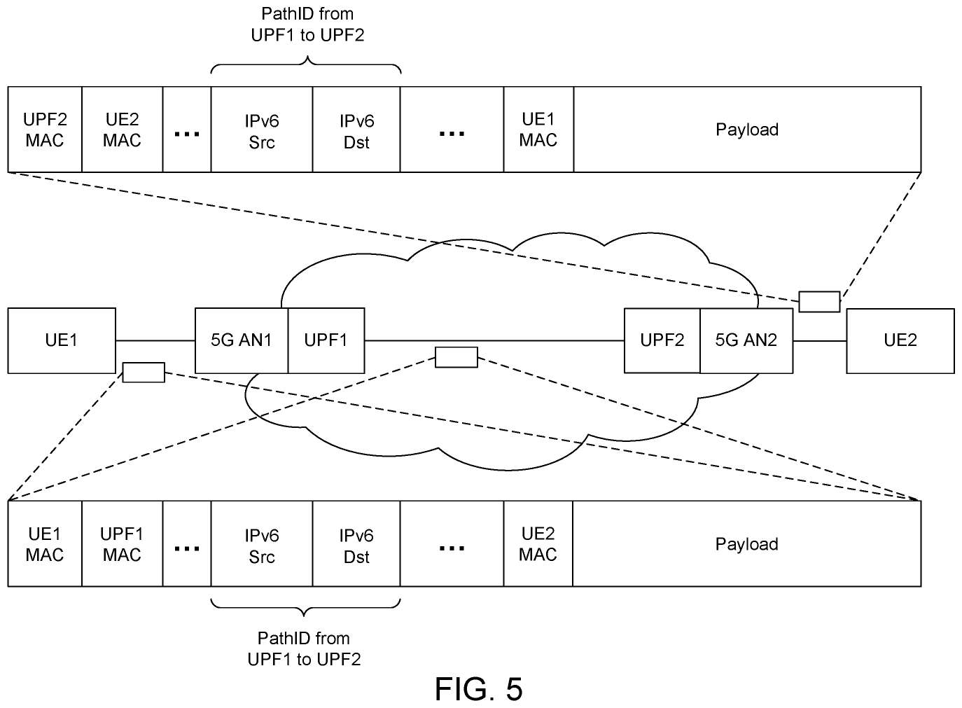

FIG. 5 illustrates an example of an end-to-end traversal of a packet. The path forwarding for a packet may be achieved by utilizing the general format (e.g., and Ethernet approaches in cases where networks based on SDN are employed) in FIG. 4 with suitable packet operations in the traversing elements. Generally, packet forwarding may comprise several aspects: L2 MAC information may be utilized to send traffic from a (L2) source to an L2 destination for link-local UE/PCE to UPF communication; the UPF node may forward a packet based on the pathID information, following the bit-field based forwarding approaches, where the receiving L2 node is UPF collocated with a 5G AN node; and/or, the UPF node may utilize its own MAC information as well as the provided destination MAC address in the general frame format payload (i.e., UE2MAC in FIG. 3) to send the packet over the link-local L2 connection upon arrival of the packet at the destination UPF.

Specifically looking at FIG. 5, a packet may originate on the left-hand side with the information provided in the example of the general frame format in FIG. 4 (i.e., the L2 MAC information contains that of UE1 and the UPF1). The MAC information of the destination (i.e., UE2) may be included in the payload of the frame together with the higher-layer payload (e.g., the HTTP/IP-over-ICN payload when utilizing the approaches related to anchoring in ICNs). The pathID from UPF1 to UPF2, or from UPF1 to UPF3 for PCE requests being sent from UE1 to the PCE in FIG. 2B, may be included in the IPv6 source/destination address.

If the packet is not destined for a link-local UE, which may be determined by checking the UE2MAC information provided, the UPF1 node may forward the packet based on the pathID, as inserted into the IPv6 src/dst fields of the packet, when utilizing techniques based on SDN related forwarding between UPF1 and UPF2. If the packet is destined for a link-local UE, normal L2 forwarding from 5G AN1 to the link-local destination may be used. Alternatively, the general packet format between the UE and UPF, at both the receiving and sending end, might either (a) use a reference to the pathID, or (b) carry no pathID altogether when sending the packet on the link-local communication between UPF and UE. In this case, the UPF may need to provide a mapping between the reference (in case (a)) or the UE2MAC (in case (b)) to the suitable pathID. The retrieved pathID may then be inserted into the general packet format and used for forwarding from the incoming UPF to the outgoing one. At the outgoing UPF (UPF2 in FIG. 5), the pathID may then again be (a) replaced with the same reference, such as a PDU session ID, or (b) removed, before delivery over the link-local communication to the destination UE. Hence, techniques related to path-based forwarding, such SDN techniques, may be applied to all packets received on link-local links destined for remote UEs, while standard L2 forwarding may be used to send the packet to a link-local destination UE.

Upon receiving the packet at UPF2 (i.e., from a network-connected rather than a link-local wireless link) the L2 source MAC address may be replaced with the UPF2 MAC address while the UE2 and UE1 MAC information is swapped (i.e., the UE2 MAC is copied from the payload into the destination address of the L2 packet while the original UE1MAC address, arriving in the source MAC field of the incoming field, is copied in the place of the UE2MAC address). The criteria for triggering these operations may be the lack of a matching forward rule related to SDN approaches. Said another way, if the forwarding rules operate on network-connected links, no forwarding rule may be triggered since the packet is destined for a link-local wireless link. Such a case may be handled by, for example, an SDN switch where a default rule would forward the packet to the 5G AN element implementing the disclosed steps that would suitably replace the MAC information and forward the packet over the link-local wireless link. For this, a UPF may operate similar to, possibly even as an extension to existing SDN switches, where the UPF operations are implemented as a northbound control application in one scenario.

The result of these operations may be the arrival of a packet at UE2 in a well-defined format that outlines the link-local AN as the source of the packet, while the remote UE is preserved in the payload of the general frame format. With this, the UE2 may now be able to form a suitable return packet towards UE1 (e.g., for HTTP request/response communication following approaches related to anchoring in ICN) by merely swapping the L2 level source destination fields similar to current L2 Ethernet based communication.

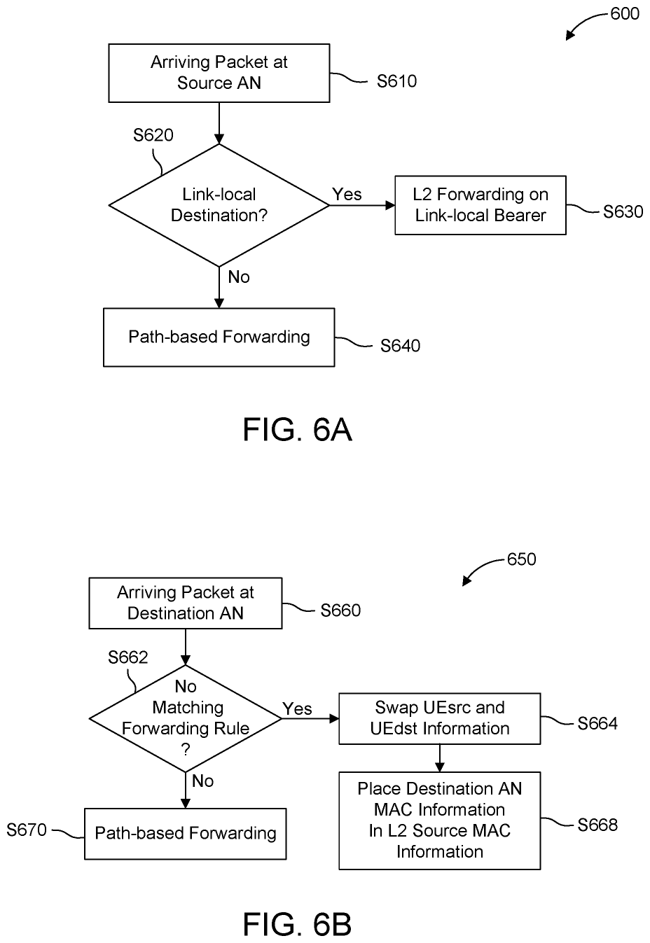

FIG. 6A shows an example flowchart 600 for source AN and FIG. 6B shows an example flowchart 650 for destination AN.

In the example flowchart in FIG. 6A, in step S610, a packet arrives at a source AN. In step S620, it is checked whether or not the destination is link-local. If the destination is link-local (i.e. ‘yes’), in step S630, the packet is forwarded using L2 forwarding on a link-local bearer. On the other hand, if the destination is not link-local (i.e. ‘no’), the packet is forwarded using path-based forwarding. Such path-based forwarding can be based on any suitable forwarding method, such as for example the solution described in Stateless Multicast Switching in Software Defined Networks. M. Reed, M. Al-Naday, N. Thomos, D. Trossen, G. Petropoulos and S. Spirou. In proceedings of ICC 2016, Kuala Lumpur, Malaysia 2016.

In the example flowchart in FIG. 6B, in step S660, a packet arrives at a destination AN and, in step S662, it is checked if there is no matching forwarding rule. In this case (i.e. ‘yes’), in step S664, source information (UEsrc) and destination information (UEdst) are swapped and, in step S668, destination AN MAC information is placed in the L2 source MAC information. Otherwise (i.e. ‘no’), in step S670, the packet is forwarded using path-based forwarding, as described with reference to step S640 in FIG. 6A.

In one embodiment, service registration for path forwarding approaches may be addressed. When considering services above Layer 2, such as those defined through IP or HTTP based operations, techniques such as anchoring in ICNs may be utilized for mapping those IP/HTTP operations onto Layer 2 exchanges as an alternative to standard IP/HTTP protocol stacks. This may be shown as the grey ‘IP/HTTP conversion’ in FIG. 3.

For cases where services such as those higher layer ones that are being requested by one UE in FIG. 2B, the service may need to be registered with the PCE in order to be able to compute suitable pathIDs (e.g., as discussed herein regarding path computation). Furthermore, the UE may also register availability purely at the Layer 2 level by registering its UEMAC as a service identifier. Note, the UEMAC may need to be operation-locally unique for registering the MAC directly as a ‘service’ to the PCE in order to avoid path computation requests being resolved to more than one UE. Further, for registering IP/HTTP based services, such as UEMAC addresses may not need to be unique since the forwarding may be defined through the combination of pathID and UEMAC where the service is hosted.

The general frame format in FIG. 4 may be utilized for sending a service registration message to the PCE. This message may be sent by the UE that hosts a specific service, such as a web service based on HTTP or its UEMAC for Layer 2 based services only. The payload of the general frame format may include suitable identifier information, such as a FQDN when registering an HTTP-based service or an IP address when registering an IP address. The payload may further include the UPF information of the service-hosting UE, where such information may either be inserted by the UPF upon traversal of the registration message to the PCE or via the UE assuming that the suitable information has been provided to the UE upon attachment to the UPF.

The PCE, upon receiving the service registration request, may store the received service identifier (e.g., the FQDN) together with the UPF and UEMAC information included in the payload (see above) and general frame format. With that, the PCE is able to maintain a mapping between registered FQDN and UPF/UEMAC information where the service is being provided. Upon receiving a path computation request for sending a message to a specific MAC or service identifier, the PCE is able to provide a suitable pathID between the respective UPF components.

In one embodiment there may be Internet-hosted services available (i.e., any service that is not directly hosted in the operator network shown in FIG. 2B). Approaches related to anchoring in ICNs may suggest a default mapping of any path computation request that cannot find a suitably registered service identified onto the default BGW (see FIG. 3). This may be similar to default mappings in standard IP/HTTP protocol stacks. Alternatively, BGWs (i.e., in cases where there exists more than one BGW) may register specific externally hosted Internet services with the PCE (i.e., using the methods as discussed herein) for traffic steering to those Internet services via the specific BGW.

In one embodiment, discovery of LAN-based services may be done by contacting the PCE in FIG. 2B. For example, a UE may send a discovery to a specific service, such as an IP address of a remote UE or the FQDN of the remote UE, using the generic packet format in FIG. 4, to the PCE. The PCE may return a response with the pathID and destination MAC address, which in turn may be used for packet forwarding according to methods described herein by the UE.

In another embodiment, the discovery response may be sent via the UPF, which may store the destination MAC and pathID information locally before forwarding the response to the UE (i.e., by either removing the pathID to the PCE or replacing it with a reference ID, such as a PDU session identifier). This mapping may be used for packet forwarding described herein, where the link-local communication between UE and UPF may not include the pathID or includes a reference ID only by retrieving the suitable pathID based on the destination UE MAC information or using said reference ID.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method at a wireless transmit receive unit (WTRU), the method comprising
creating a data packet formatted as an Ethernet frame, the data packet comprising an address of the WTRU as source address, an address of a first forwarder node as destination address, an identifier describing a path between the first forwarder node and a second forwarder node, and an end destination address, wherein the identifier is included in header fields for Internet Protocol (IP) addresses in the Ethernet frame; and
transmitting the data packet in a network to which the WTRU is connected.

2-3. (canceled)

4. The method of claim 1, wherein at least one of the source address, the destination address, and the end destination address is a Media Access Control, MAC, address.

5. The method of claim 1, wherein the path describes links in a network in which the first forwarder node and the second forwarder node are end points.

6. The method of claim 1, wherein the data packet further comprises a payload that includes the end destination address.

7. A wireless transmit receive unit (WTRU), comprising:
memory; and
a processor configured to:
create a data packet formatted as an Ethernet frame, the data packet comprising an address of the WTRU as source address, an address of a first forwarder node as destination address, an identifier describing a path between the first forwarder node and a second forwarder node, and an end destination address, wherein the identifier is included in header fields for Internet Protocol (IP) addresses in the Ethernet frame; and
transmit the data packet in a network to which the WTRU is connected.

8-11. (canceled)

12. A method at a first forwarder node comprising:
receiving a data packet from a source wireless transmit receive unit (WTRU), wherein the data packet is addressed to the first forwarder node;
forwarding the data packet towards a second forwarder node based on information in the data packet, the information describing a path between the first forwarder node and the second forwarder node;
receiving a further data packet from the second forwarder node, the further data packet comprising the identifier and an address of the source WTRU; and
forwarding the further data packet towards the source WTRU.

13. (canceled)

14. The method of claim 12, further comprising, before the forwarding of the further data packet, setting an address of the source WTRU as destination address of the further data packet.

15. The method of claim 14, wherein the address of the source WTRU is a Media Access Protocol, MAC, address.

16. The method of claim 12, wherein the further data packet was transmitted over the path between the first forwarder node and the second forwarder node.

17. The method of claim 12, wherein the data packet is formatted as an Ethernet frame and
wherein header fields for Internet Protocol (IP) addresses are interpreted as the information.

18. The method of claim 17, wherein the data packet comprises a Media Access Protocol, MAC, address of the first forwarder node.

19. The method of claim 12, wherein the path describes links in a network in which the first forwarder node and the second forwarder node are end points.

20. A first forwarder node comprising:
memory; and
a processor configured to:
receive a data packet from a source wireless transmit receive unit (WTRU), wherein the data packet is addressed to the first forwarder node;
forward the data packet towards a second forwarder node based on information in the data packet, the information describing a path between the first forwarder node and the second forwarder node;
receive a further data packet from the second forwarder node, the further data packet comprising the identifier and an address of the source WTRU; and
forward the further data packet towards the source WTRU.

21. A non-transitory computer readable storage medium storing instructions which when executed by a processing device cause the processing device to:
create a data packet formatted as an Ethernet frame, the data packet comprising an address of the WTRU as source address, an address of a first forwarder node as destination address, an identifier describing a path between the first forwarder node and a second forwarder node, and an end destination address, wherein the identifier is included in header fields for Internet Protocol (IP) addresses in the Ethernet frame; and
transmit the data packet in a network to which the WTRU is connected.

22. A non-transitory computer readable storage medium storing instructions which when executed by a processing device cause the processing device to:
receive a data packet from a source wireless transmit receive unit (WTRU), wherein the data packet is addressed to the first forwarder node;
forward the data packet towards a second forwarder node based on information in the data packet, the information describing a path between the first forwarder node and the second forwarder node;
receive a further data packet from the second forwarder node, the further data packet comprising the identifier and an address of the source WTRU; and
forward the further data packet towards the source WTRU.
